(19) United States
(12) Patent Application Publication
(10) Pub. No.: US 2012/0287160 A1
(43) Pub. Date: Nov. 15, 2012

(54) DISPLAY DEVICE AND ROTATION METHOD OF SAME

(75) Inventor: XIN GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/158,477

(22) Filed: Jun. 13, 2011

(30) Foreign Application Priority Data
May 12, 2011 (CN) 201110121599.0

(51) Int. Cl. G09G 5/00

(52) U.S. Cl. 345/649

(57) ABSTRACT

A display device includes a display screen, an image capturing device for capturing real-time images of a user, a direction unit, an angle calculation unit, and a control unit. The direction unit determines a first desired rotation direction around a first axis and a second desired rotation direction around a second axis based on the movement of the head image of the user in the real-time images. The angle calculation unit calculates a first desired rotation angle around the first axis and a second desired rotation angle around the second axis based on the movement of the head image of the user in the real-time images. The control unit controls the display screen to rotate in the first desired rotation direction by the first desired rotation angle and controls the display screen to rotate in the second desired rotation direction by the second desired rotation angle.

### BACKGROUND

1. Technical Field

The present disclosure relates to a display control technology and particularly to, a display device and a rotation method of such display device.

2. Description of Related Art

Many display devices have a display screen fixed in a horizontal direction or a vertical direction. Thus, the display direction of the display screen cannot be changed without the display device being manually rotated.

When the display device is used, a user usually chooses a comfortable posture to view a figure/graph/e-book/photo on the display screen. However, after a long time of viewing, the user may become tired, and may move his body and his view point away from the central view point of the display screen. The image on the display screen can thus be inclined making the image unclear and hard to view.

Therefore, what is needed is a new display device and a rotation method of the display device that can overcome the described limitations.

### BRIEF DESCRIPTION OF THE DRAWINGS

FIG. 1 is a structure isometric view of a display device according to an exemplary embodiment.

FIG. 2 is a functional block diagram of the display device in FIG. 1.

FIG. 3 is a schematic view of a movement of a central point of a head image of a user.

FIG. 4 is a working principle diagram of an angle calculation unit of the display device in FIG. 2.

FIG. 5 is a working principle diagram of the angle calculation unit of the display device in FIG. 2 from another aspect.

FIG. 6 is a flow chart of a rotation method of the display device in FIG. 1.

### DETAILED DESCRIPTION

Embodiments will now be described in detail below with reference to drawings.

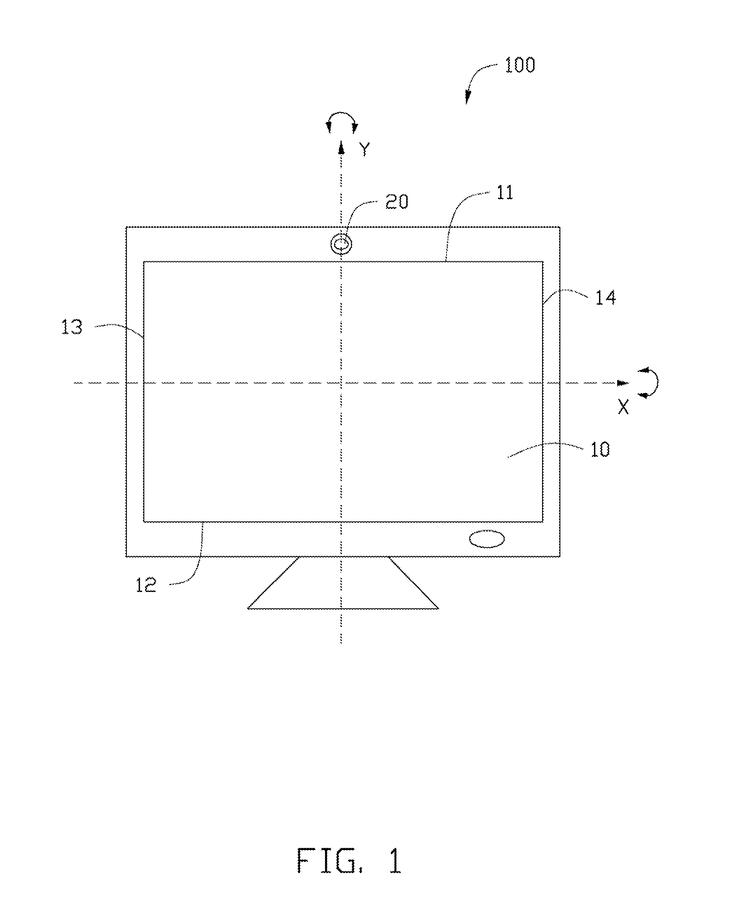

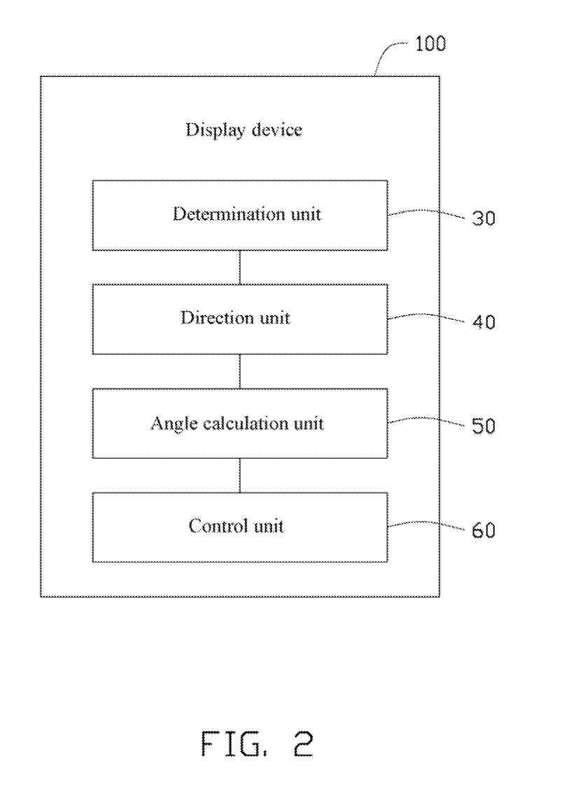

Referring to FIGS. 1 and 2, a display device 100, in accordance with an exemplary embodiment, includes a display screen 10, an image capturing device 20, a determination unit 30, a direction unit 40, an angle calculation unit 50, and a control unit 60. When there is one user, the display screen 10 can rotate with the head of the user moving until the display screen 10 reaches a most comfortable and convenient viewing position for the user to clearly view a figure/graph/e-book/photo on the display screen 10; if there are many users, the display screen cannot rotate with the head movement of a random user. In the present embodiment, there is one user viewing the display device 100. In addition, in the present embodiment, when a connecting line of a central point of the head of the user and a central point of the display screen 10 is perpendicular to the display screen 10, it allows the user to view the image from the most comfortable and convenient viewpoint. In other embodiments, other positions may be defined as the most comfortable and convenient viewing position.

The display screen 10 displays the figure/graph/e-book/photo, and includes a top side 11, a bottom side 12 parallel with the top side 11, a left side 13, a right side 14 parallel with the left side 14. A horizontal axis parallel with the top side 11 is defined as a first axis X, and a vertical axis parallel with the left side 13 is defined as a second axis Y.

The image capturing device 20 is arranged on a periphery of the display screen 10, and a specific position of the image capturing device 20 can be chosen freely based on user requirements. In the present embodiment, the image capturing device 20 is arranged above the top side 11 of the display screen 10, the image capturing device 20 is in a working state when the display screen 100 is working. The image capturing device 20 captures a real-time image of the head of the user. In the present embodiment, the image capturing device 20 is a fixed-focus camera module.

The determination unit 30 determines changes in the position of the head of the user based on changes in the position of the head image of the user in captured images. When the position of a central point of the head image in the captured images changes, the direction unit 40, the angle calculation unit 50, and the control unit 60 will be started. In detail, if the position of the central point of the head image in the first shot coincides with the position of the central point of the head image in the second shot, the position of the central point of the head image has not moved (i.e. the head of the user has not moved). If the position of the central point of the head image in the first shot does not coincide with the position of the central point of the head image in the second shot, it is determined that the position of the central point of the head image has moved (i.e. the head of the user has moved). In the actual operation, a time interval between two adjacent shots may be about three seconds. When the position of the central point of the head image in the captured images changes, the time interval between two adjacent shots may be changed to one second, such that the position of the central point of the head image after the user moving can be timely recorded by the image capturing device 20, and subsequent operation can thus be more accurate. In addition, if the head image moves slightly (i.e. the head of the user moves slightly), and the slight movement does not go beyond a central viewpoint for the user to comfortably view the display, the display screen 10 does not need to adjust orientation. That is, in the actual operation, a critical movement of the position of the central point of the head image may be defined. Only when the movement of the position of the central point of the head image is greater than the critical movement, will adjustments to the display screen 10 be made.

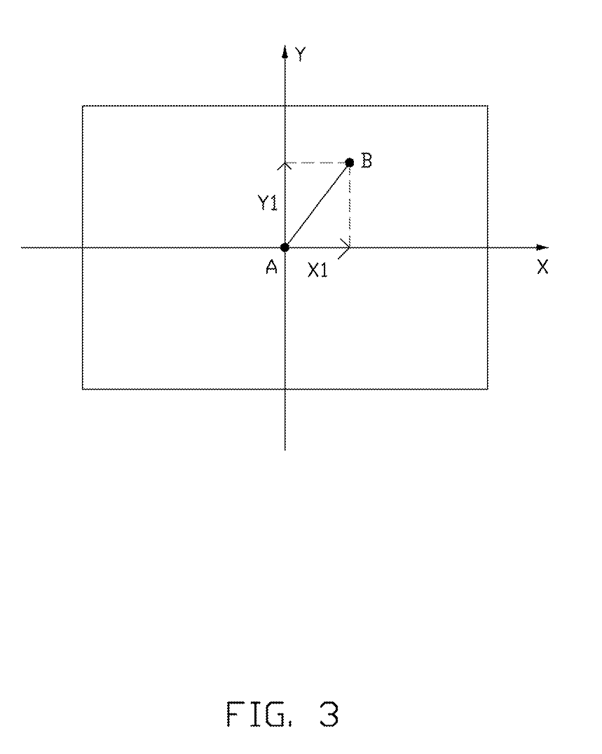

Referring also to FIG. 3, the direction unit 40 determines rotation directions of the display screen 10. In detail, a horizontal rotation of the display screen 10 around the second axis Y is determined by a horizontal movement direction of the head image captured at an original position and a terminal position along the first axis X. In addition, a vertical rotation direction of the display screen 10 around the first axis X is determined by a vertical movement direction of the head image captured at the original position and the terminal position along the second axis Y. Wherein, the original position is a shooting position where the head of the user starts to move each time, and the terminal position is a shooting position where the head of the user stops moving each time.

For example, if the central point of the head image captured at the original position is positioned at A in a captured image and the central point of the head image captured at the terminal position is positioned at B in another captured image, the head of the user moves to the left lower side based on imaging principle. Accordingly, the display screen 10 should be rotated from right to left around the second axis Y and then rotated from up to down around the first axis X, such that the connecting line between the central point of the head of the user and the central point of the display screen 10 can be perpendicular to the display screen 10. In other embodiments, the display screen 10 may be rotated from up to down around the first axis X and then rotated from right to left around the second axis Y.

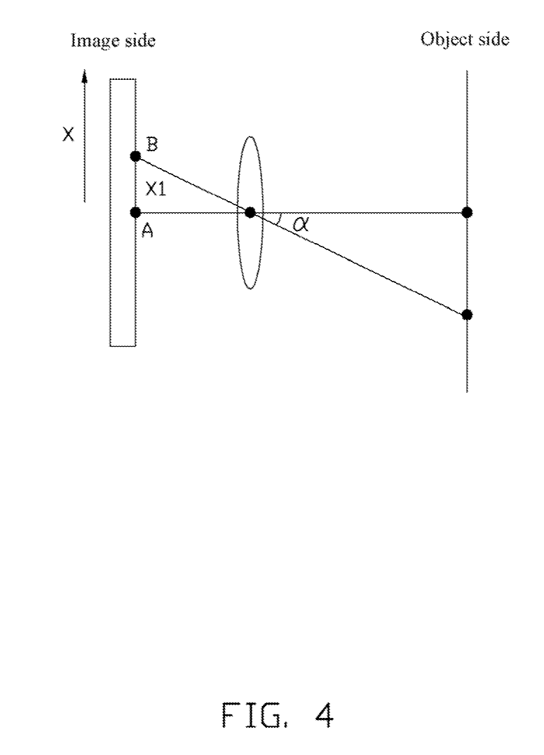

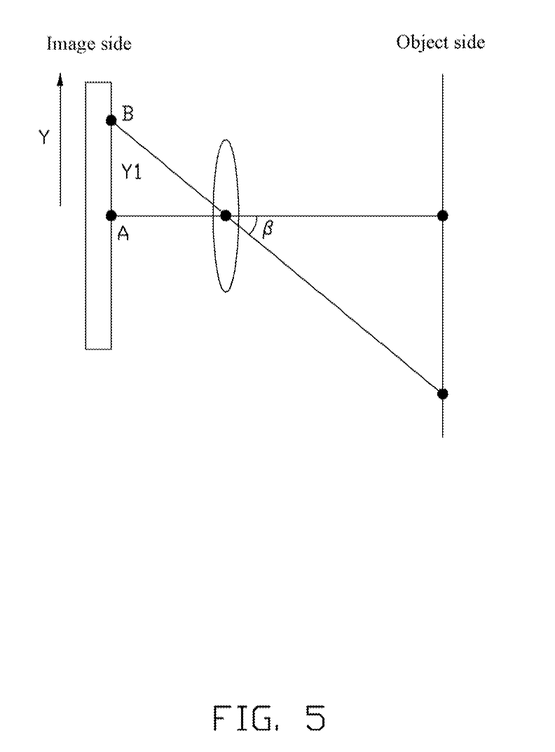

Referring to FIGS. 4 and 5, the angle calculation unit 50 calculates a desired rotation angle of the display screen 10 around the second axis Y based on a movement distance of the central point of the head image captured at the original position and the terminal position along the first axis X. In addition, calculates a desired rotation angle of the display screen 10 around the first axis X based on a movement distance of the central point of the head image captured at the original position and the terminal position along the second axis Y.

In detail, based on the position A and the position B in the two captured images, a movement distance X1 of the head image along the first axis X is obtained. A desired rotation angle a of the display screen 10 around the second axis Y can be calculated based on the image distance of the image capturing device 20, the movement distance X1, and tangent function. Based on the position A and the position B in the two captured images, a movement distance Y1 of the head image along the second axis Y is obtained. In addition, a desired rotation angle β of the display screen 10 around the first axis X can be calculated based on the image distance of the image capturing device 20, the movement distance Y1, and tangent function.

The control unit 60 is configured for controlling the display screen 10 to rotate based on rotation directions output by the direction unit 40 and rotation angles output by the angle calculation unit 50. Such that the connecting line between the central point of the head of the user and the central point of the display screen 10 is perpendicular to the display screen 10. It is understood that the display device 100 also includes driving structures (not shown) connected to the display screen 10 and the control unit 60. The control unit 60 controls the driving structures to drive the display screen 10 to rotate around the first axis X or the second axis Y.

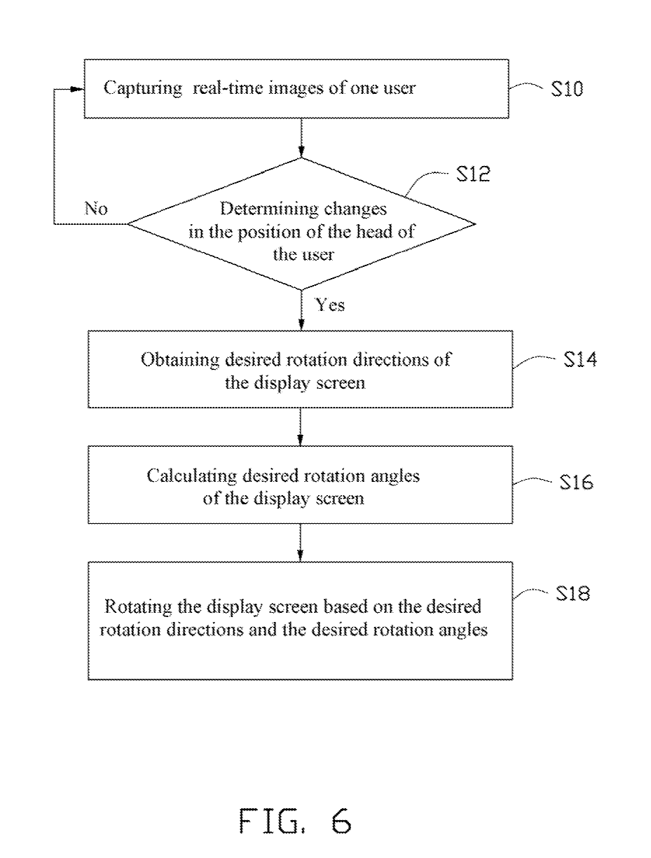

Referring to FIG. 6, an exemplary embodiment of a rotation method of the display device 100 is provided.

In step S10, real-time images of the head of one user are captured.

In step S12, changes in the position of the head of the user are determined. If the position of the head of the user changes, step S14 (see details below) is performed. If the position of the head of the user does not change, step 10 is performed again.

In step S14, desired rotation directions of the display screen 10 are obtained based on the changes in the position of the head of the user. In detail, a horizontal rotation direction of the display screen 10 around the second axis Y is determined by a horizontal movement of the head image captured at the original position and the terminal position along the first axis X. In addition, a vertical rotation direction of the display screen 10 around the first axis X is determined by a vertical movement direction of the head image captured at the original position and the terminal position along the second axis Y.

In step S16, desired rotation angles of the display screen 10 are calculated based on the changes in the position of the head of the user. In detail, a desired rotation angle of the display screen 10 around the second axis Y can be calculated based on the movement distance of the head image captured along the second axis Y. In addition, a desired rotation angle of the display screen 10 around the first axis X can be calculated based on the movement distance of the head image captured along the second axis Y.

In step S18, the rotation of the display screen 10 is controlled by the control unit 60 based on the desired rotation directions and the desired rotation angles. Such that the connection line between the central point of the head of the user and the central point of the display screen 10 is perpendicular to the display screen 10.

When the position of the head image changes, the display screen 10 can automatically rotate with the movement of the head of the user, such that the connecting line between the central point of the head of the user and the central point of the display screen 10 is perpendicular to the display screen 10. Accordingly, it is more comfortable for the user to view the figure/graph/e-book/photo on the display screen 10.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope and spirit of the appended claims.

What is claimed is:

1. A display device comprising:
a display screen comprising a top side, a bottom side parallel with the top side, a left side, and a right side parallel with the left side;
an image capturing device arranged on a periphery of the display screen, the image capturing device being configured for capturing real-time images of a user;
a direction unit configured for determining a first desired rotation direction of the display screen around a first axis parallel with the top side, and determining a second desired rotation direction of the display screen around a second axis parallel with the left side, the first desired rotation direction being determined based on a movement direction of the head image of the user in the real-time images along the second axis, the second desired rotation direction being determined based on a movement direction of the head image of the user in the real-time images along the first axis;
an angle calculation unit configured for calculating a first desired rotation angle of the display screen around the first axis, and calculating a second desired rotation angle of the display screen around the second axis, the first desired rotation angle being calculated based on a movement distant of the head image of the user in the real-time images from an original position to a terminal position along the second axis, the second desired rotation angle being calculated based on another movement distant of the head image in the real-time images from the original position to the terminal position along the first axis; and
a control unit configured for controlling the display screen to rotate in the first desired rotation direction by the first desired rotation angle and controlling the display screen to rotate in the second desired rotation direction by the second desired rotation angle, such that the connecting line between a central point of the head of the user and a central point of the display screen is substantially perpendicular to the display screen.

2. The display device of claim 1, wherein the image capturing device is a fixed-focus camera module.

3. The display device of claim 1, further comprising a determination unit configured for determining changes in the position of the head image of the user in the real-time images and activating the direction unit, the angle calculation unit and the control unit to work upon a condition that the position of the head image changes in the real-time images.

4. The display device of claim 1, wherein the original position is a shooting position where the head of the user starts to move, and the terminal position is a shooting position where the head of the user stops moving.

5. The display device of claim 1, wherein the angle calculating unit is configured for calculating the first desired rotation angle based on the image distance of the image capturing device, the movement distance of the head image in the real-time images from the original position to the terminal position along the second axis, and tangent function.

6. The display device of claim 1, wherein the angle calculating unit is configured for calculating the second desired rotation angle based on the image distance of the image capturing device, the movement distance of the head image in the real-time images along the first axis, and tangent function.

7. A rotation method of a display device, the display device comprising a display screen, the rotation method comprising:
capturing real-time images of a user;
obtaining a first desired rotation direction around a horizontal axis and a second desired rotation direction around a vertical axis upon a condition that the position of the head image of the user is determined to change in the real-time images, wherein the first desired rotation direction is obtained based on a movement direction of the head image of the user in the real-time images along the vertical axis, the second desired rotation direction is obtained based on a movement direction of the head image of the user in the real-time images along the horizontal axis;
calculating a first desired rotation angle around the horizontal axis and a second desired rotation angle around the vertical axis, wherein the first desired rotation angle is calculated based on a movement distant of the head image of the user in the real-time images from an original position to a terminal position along the vertical axis, the second desired rotation angle is calculated based on another movement distant of the head image in the real-time images from the original position to the terminal position along the horizontal axis; and
rotating the display screen in the first desired rotation direction by the first desired rotation angle and rotating the display screen in the second desired rotation direction by the second desired rotation angle.

8. The rotation method of claim 7, wherein the original position is a shooting position where the head of the user starts to move, and the terminal position is a shooting position where the head of the user stops moving.

9. The rotation method of claim 7, wherein the display device comprising an image capturing device arranged on a periphery of the display screen, the real-time images are captured by the image capturing device, the first desired rotation angle is calculated based on the image distance of the image capturing device, the movement distance of the head image in the real-time images from the original position to the terminal position along the vertical axis, and tangent function.

10. The rotation method of claim 9, wherein the second desired rotation angle is calculated based on the image distance of the image capturing device, the movement distance of the head image in the real-time images from the original position to the terminal position along the horizontal axis, and tangent function.
